(19) United States
(12) Patent Application Publication
(10) Pub. No.: US 2005/0059429 A1
(43) Pub. Date: Mar. 17, 2005

(54) Inter-communication mobile phone set

(76) Inventors: Sheng Feng Liu, Taichung Hsien (TW); Sheng Yung Liu, Taichung Hsien (TW)

Correspondence Address: SHENG FENG LIU, 235 Chung - Ho, Box 10-69, Taipei, TW

(21) Appl. No.: 10/662,413

(22) Filed: Sep. 16, 2003

(51) Int. Cl. H04M 1/00

(52) U.S. Cl. 455/558

(57) ABSTRACT

An inter-communication mobile phone set comprises a main phone, a SIM card and a plurality of sub-phones. The main phone is one of a multi-user main phone, a personal main phone, and an in-car main phone; the multi-user main phone, personal main phone and in-car main phone searching for sub-phones automatically and the frequencies thereof so that signals of the main phone and sub-phones can inter-communicate to one another. The main phone is connected to other main phone through a SIM card. The sub-phone has a type selected from one of a simple type, a pen-form sub-phone, a neck-tie form phone, a watch form sub-phone, a breast-suspending sub-phone, an ear-phone form sub-phone, a hat form sub-phone. The sub-phone is built in one of a portable audio, a translator, a notebook computer, a PDA, a personal computer expansion card, a pocket, a game machine, a camera.

### FIELD OF THE INVENTION

The present invention relates to communications, and more particularly to an inter-communication mobile phone set, which can search for a sub-phone in any position. The sub-phones can be installed to various products.

### BACKGROUND OF THE INVENTION

Current communication systems must be executed through the phone companies and thus users pay charge to phone companies. However, in many groups, the communications are very frequent so that the prior art will induce a large fee. Moreover, the current phone has a dull appearance and generally, it has a single use devcie.

Thereby, there is an eager demand for a novel design which can improve the deficiency in the prior art. In that, phones have a various shapes. A main phone can communicate with a plurality of sub-phones and the communication between the main phone and sub-phones are charge-free.

### SUMMARY OF THE INVENTION

Accordingly, the primary object of the present invention is to provide an inter-communication mobile phone set which comprises a main phone, a SIM card and a plurality of sub-phones. The main phone is one of a multi-user main phone, a personal main phone, and an in-car main phone; the multi-user main phone, personal main phone and in-car main phone searching for sub-phones automatically and the frequencies thereof so that signals of the main phone and sub-phones can inter-transfer to one another. The main phone is connected to other main phone through a SIM card. The sub-phone has a type selected from one of a simple type, a pen-form sub-phone, a neck-tie form phone, a watch form sub-phone, breast-suspending sub-phone, ear-phone form sub-phone, a hat form sub-phone. The sub-phone is built in one of a portable audio, a translator, a notebook computer, a PDA, a personal computer expansion card, a pocket, a game machine, a camera etc.

The various objects and advantages of the present invention will be more readily understood from the following detailed description when read in conjunction with the appended drawing.

### BRIEF DESCRIPTION OF THE DRAWINGS

FIG. 1 shows a schematic view about the multi-user main phone of the present invention.

FIG. 2 is a schematic view about the personal main phone of the present invention.

FIG. 3 is a schematic view about the in-car main phone of the present invention.

FIG. 4 is a schematic view about the pen-form sub-phone the present invention.

FIG. 5 is a schematic view about the neck-tie form phone of the present invention.

FIG. 6 is a schematic view about the watch form sub-phone of the present invention.

FIG. 7 is a schematic view about the breast suspending form sub-phone of the present invention.

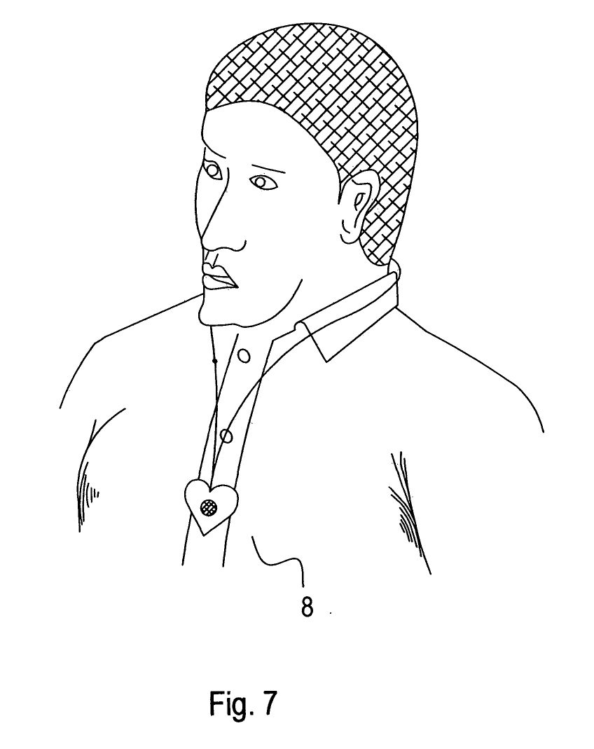

FIG. 8 is a schematic view about the ear-phone form sub-phone of the present invention.

FIG. 9 is a schematic view about the hat form sub-phone of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

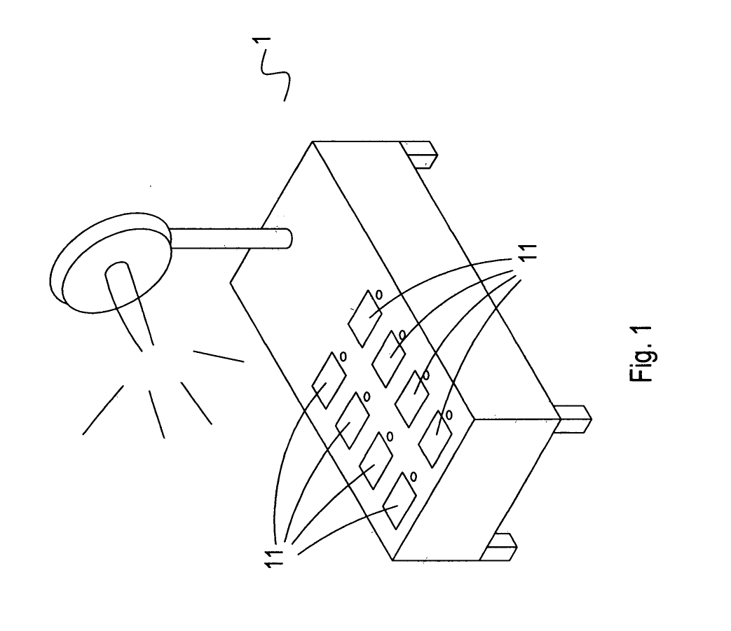

Referring to FIG. 1, the inter-communication mobile phone set of the present invention is illustrated. The inter-communication mobile phone set of the present invention includes a main phone, a SIM card and a plurality of sub-phones.

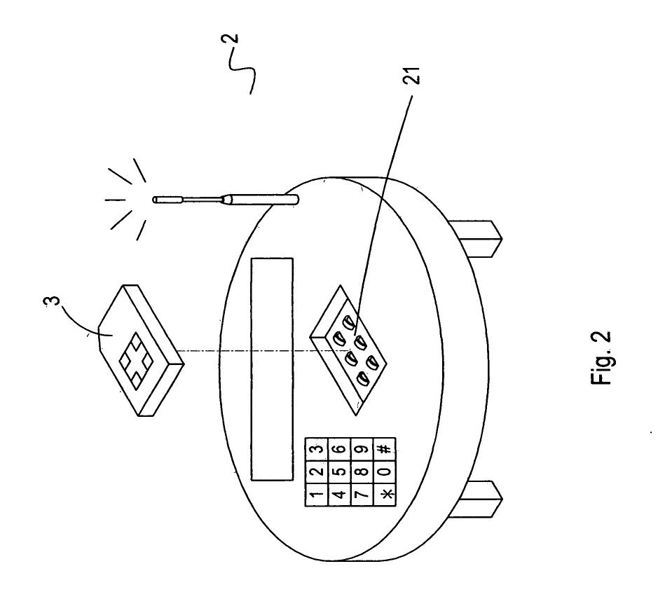

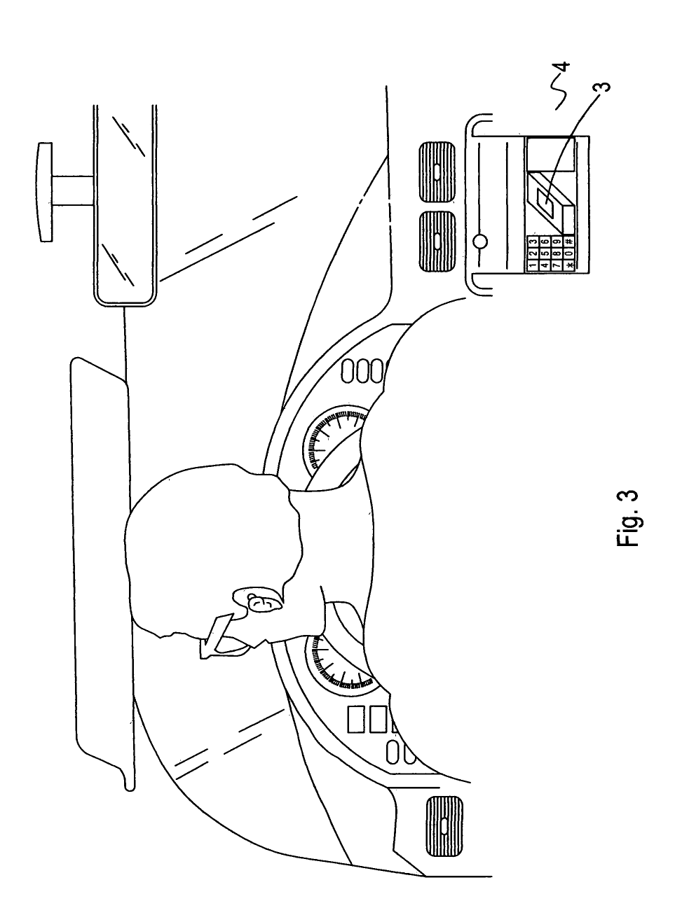

The main phone may be one of a multi-user main phone 1 (referring to FIG. 1), a personal main phone 2 (referring to FIG. 2), and an in-car main phone 4 (referring to FIG. 3). The multi-user main phone 1, personal main phone 2 and in-car main phone 4 can search for sub-phones automatically and the frequencies thereof so that signals of the main phone and sub-phones can inter-communicate with one another. The main phone can be connected to other main phone through a SIM card 3 (for example, a SIM card 3 is inserted into a SIM slot 11, 21 of a multi-user main phone 1, or a personal main phone 2 or an in-car main phone 4). Then, a sub-phone can be searched and interconnected. Moreover, the inter-communication mobile phone set can be used in wired or wireless system. In a hospital, the SIM slot can be redirected to an indoor phone. Thereby, no electromagnetic wave problem occurs.

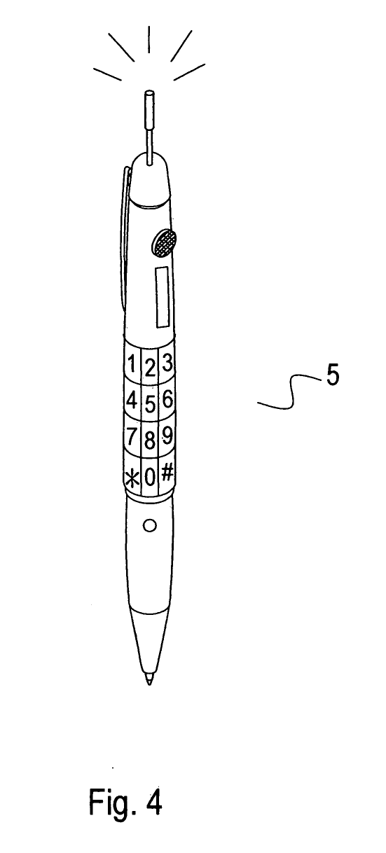

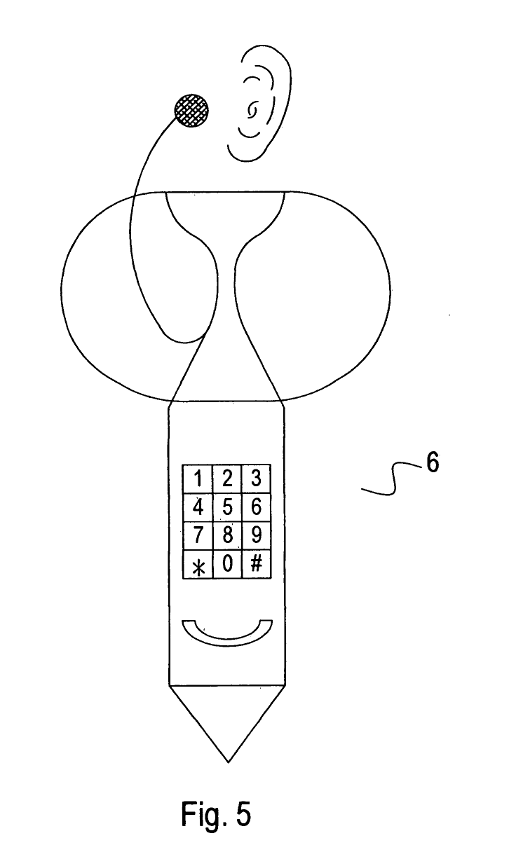

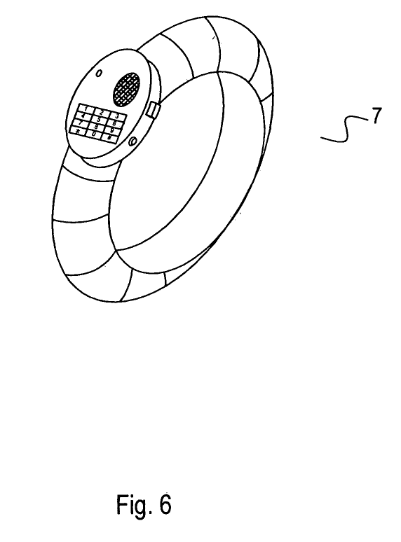

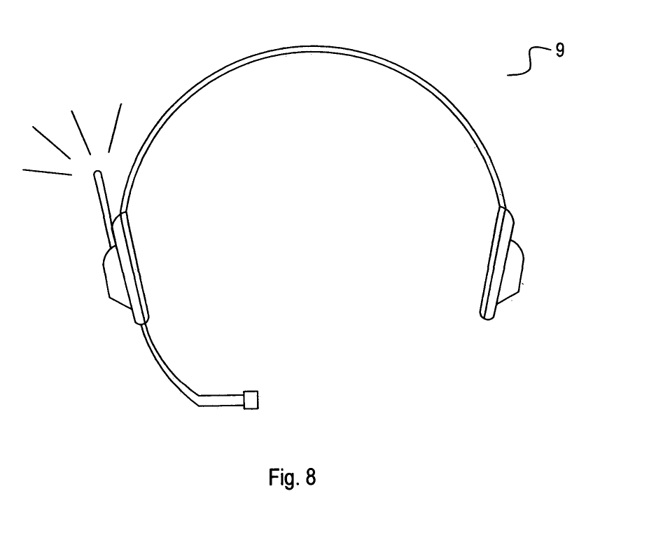

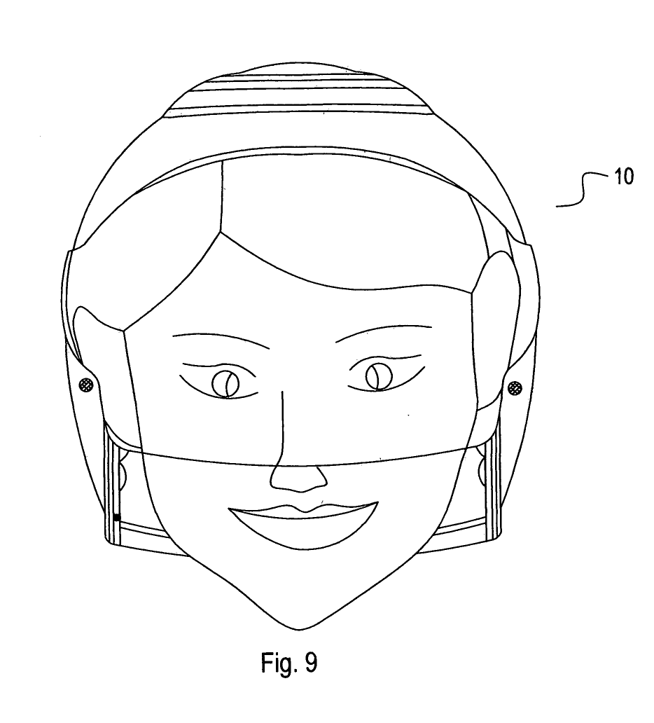

The sub-phone can be a simple type, a pen-form sub-phone 5 (referring to FIG. 4), a neck-tie form phone 6 (referring to FIG. 5), a watch form sub-phone 7 ((referring to FIG. 6), a breast-suspending sub-phone 8 (referring to Pig. 7), an ear-phone form sub-phone 9 (referring to FIG. 8), a hat form sub-phone 10 (referring to FIG. 9), or built in a portable audio, a translator, a notebook computer, a PDA, a personal computer expansion card, a pocket, a game machine, a camera etc. All these can achieve the function of intercommunication of the main phone and sub-phone.

The user only need carry a dedicate SIM card 3 and a matched sub-phone. When the user arrives to an area where the main phone is located. The communication of the sub-phone and main phone can be achieved. In the inter-communication mobile phone set of the present invention, no dead area exists and no fee is necessary as the international communication system.

In general, a wireless intercom or a wireless phone is used in some predetermined vehicle, but this is not existed in the present invention.

The inter-communication mobile phone set of the present invention is different from the current used portable code which must be set, while this is not necessary in the present invention. Moreover, the present invention can be used in various vehicles and thus the use thereof is more widely

Advantages of the present invention will be described herein. In the present invention, only one main phone is used with a plurality of sub-phones and thus the cost is saved. No interference or electromagnetic wave problem occurs and thus the present invention can be used in hospitals. The main phone can be used with sub-phones of different forms so that the main phone can be carried out conveniently. The present invention can be connected to a world wide net.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

1. An inter-communication mobile phone set comprising a main phone, a SIM card and a plurality of sub-phones;
the main phone being one of a multi-user main phone, a personal main phone, and an in-car main phone; the multi-user main phone, personal main phone and in-car main phone searching for sub-phones automatically and the frequencies thereof so that signals of the main phone and sub-phones inter-communicate to one another; the main phone being connected to other sub phone through a SIM card.

2. The inter-communication mobile phone set as claimed in claim 1, wherein the sub-phone has a type selected from one of a simple type, a pen-form sub-phone, a neck-tie form phone, a watch form sub-phone, a breast-suspending sub-phone, an ear-phone form sub-phone, a hat form sub-phone.

3. The inter-communication mobile phone set as claimed in claim 1, wherein the sub-phone is built in one of a portable audio, a translator, a notebook computer, a PDA, a personal computer expansion card, a pocket, a game machine, a camera etc.

4. The inter-communication mobile phone set as claimed in claim 1, wherein the inter-communication mobile phone set has no interference of electromagnetic wave and is installed in a hospital.

5. The inter-communication mobile phone set as claimed in claim 1, wherein the inter-communication mobile phone set is connected to Internet.

6. The inter-communication mobile phone set as claimed in claim 1, wherein the inter-communication mobile phone set is used in one of a wired system and a wireless system.

7. The inter-communication mobile phone set as claimed in claim 1, wherein the inter-communication mobile phone set is used in a hospital, and then is redirected to an indoor phone without electromagnetic wave interference.

8. The inter-communication mobile phone set as claimed in claim 1, wherein no setting operation is used in the inter-communication mobile phone set, and thus the inter-communication mobile phone set is used in a variety of vehicles.
